(19) United States
(12) Patent Application Publication
(10) Pub. No.: US 2026/0351145 A1
(43) Pub. Date: Nov. 5, 2026

(54) SHOW WINDOW

(71) Applicant: INTERMAN Corporation, Kagoshima-shi, Kagoshima (JP)

(72) Inventors: Shigeki UETABIRA, Kagoshima-shi (JP); Yoshimasa SAITOH, Tokyo (JP)

(73) Assignee: INTERMAN Corporation, Kagoshima-shi, Kagoshima (JP)

(21) Appl. No.: 19/484,901

(22) PCT Filed: May 25, 2024
(86) PCT No.: PCT/JP2024/019311

§ 371 Date: Nov. 17, 2025

(30) Foreign Application Priority Data
Jun. 12, 2023 (JP) 2023-095984

(51) Int. Cl. G09F 19/12; G02B 5/124; G02B 30/56; H04N 13/302

(52) U.S. Cl. CPC G09F 19/12; G02B 5/124; G02B 30/56; H04N 13/302

(57) ABSTRACT

[Problem to be Solved] To provide a show window capable of creating an effect as if an image were directly emerging from a wall, thereby improving its ability to attract attention.
[Abstract] The show window comprises a wall surface with a window and an aerial image display device provided on the inner side of the window.

The aerial image display device projects an aerial image to the outside of the window. The aerial image display device includes an object to be projected, which is the source of the aerial image, and a retro-transmissive optical plate disposed at a fixed angle between the object to be projected and the window, allowing the aerial image to be projected through a transparent plate fitted in the window. In one embodiment, a dark sheet that minimizes reflection and scattering of light is provided on the inner surfaces of the space inside the window where the aerial image display device is installed.

### FIELD OF THE INVENTION

The present invention relates to a show window utilizing aerial images.

### BACKGROUND ART

In recent years, interest in aerial image display devices has been increasing. One of the factors is the need for non-contact interaction during the COVID-19 pandemic. That is, they are used as an alternative to touch panels in combination with sensors. For example, in bank ATMs, self-checkout counters at supermarkets, corporate reception desks, and hotel check-ins, an unspecified number of users operate the same touch panel.

Such touch panels can become potential infection routes. To avoid this risk, the touch panel would have to be disinfected each time a user changes, but such a measure is quite labor-intensive and difficult to perform thoroughly.

A non-contact interface using an aerial image display device allows the same usability as a conventional touch panel while avoiding infection risk without such effort. For example, Patent Document 1 discloses a non-contact remote pointer control device using aerial imaging technology, operated by a surgeon without touching a pointing device such as a mouse, to avoid hygiene issues during surgery. As a special optical element usable in such aerial imaging technology, an optical imaging device disclosed in Patent Document 2 is known.

The appearance of an image floating in empty space by means of aerial imaging technology alone creates a strong impression and helps create a futuristic atmosphere. For this reason, many applications other than infection prevention can be envisioned. For example, the technology disclosed in Patent Document 3 shows an example of using this method as a substitute for gates at train station ticket barriers. Furthermore, because an image displayed as an aerial image appears to float above its surroundings, it provides a sense of depth and high entertainment value, and is expected to have potential applications in games and similar fields.

### PRIOR ART DOCUMENTS

### Patent Documents

Patent Document 1: Japanese Patent Published Application No. 2018-147054

Patent Document 2: International Publication No. 2009/131128

Patent Document 3: Japanese Patent Published Application No. 2017-142370

### SUMMARY OF THE INVENTION

### Problems to be Solved by the Invention

Indeed, although an image displayed as an aerial image appears to float in the air, in conventional aerial image display devices, it still looks as though it is being projected from a device, and thus lacks a sense of natural surprise.

Accordingly, the object of the present invention is to provide a show window that gives the impression that an image is emerging directly from a wall, thereby improving its ability to attract attention.

### Means for Solving the Problems

To achieve the above object, one aspect of the show window according to the present invention comprises a window provided in a wall surface, and an aerial image display device provided inside the window, wherein the aerial image display device projects an aerial image to the outside of the window.

In one embodiment, the aerial image display device comprises an object to be projected, which is the source of the aerial image, and a retro-transmissive optical plate interposed at a fixed angle between the object to be projected and the window.

In another embodiment, the inner space of the window in which the aerial image display device is installed has its inner surface treated to suppress reflection and scattering of internal light.

In another embodiment, a transparent plate is fitted into the window, and the aerial image display device projects the aerial image through the transparent plate.

In another embodiment, the object to be projected is a display device capable of freely displaying images.

### Effects of the Invention

According to the show window of the present invention, it is possible to attract the attention of a greater number of passersby.

### BRIEF DESCRIPTION OF THE DRAWINGS

FIG. 1 is a sectional view showing the structure of the show window according to Example 1 of the present invention.

FIG. 2 is a sectional view showing the structure of the show window according to Example 1 of the present invention as an example in which a depth camera sensor 9 is provided at the lower part of the window frame.

FIG. 3 is a sectional view showing the structure of the show window according to Example 2 of the present invention.

FIG. 4 is a perspective view of a vending machine equipped with the show window according to Example 3 of the present invention.

FIG. 5 is a partial sectional view showing the show window of the vending machine shown in FIG. 4.

FIG. 6 is a partial perspective view explaining the positional relationship among the main components of the aerial image display device that constitutes the show window of the vending machine shown in FIG. 4.

### EMBODIMENTS FOR CARRYING OUT THE INVENTION

### Example 1

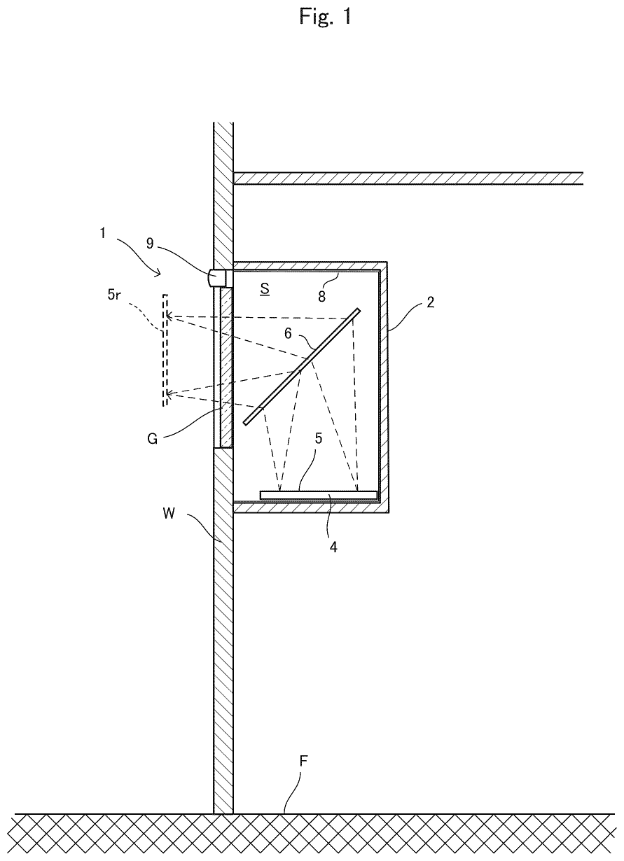

Hereinafter, embodiments of the show window according to the present invention will be described with reference to the accompanying drawings. FIG. 1 is a sectional view showing the structure of a show window 1 according to Example 1 of the present invention. The right side inside a wall W corresponds to the interior of the room, and the left side corresponds to the exterior. The wall W may be either an exterior wall of a building or a partition wall separating a tenant space within a commercial building.

As shown in FIG. 1, a window is provided at about eye level above floor F, and a glass plate G is fitted into it. A rectangular hollow housing 2, open on its left side, is fixed to the wall W from the inside so as to cover the window containing the glass plate G. A closed rectangular space S is thereby formed inside by the housing 2, the wall W, and the window.

The inside space S, a tablet computer 4 is horizontally installed at the bottom, and the optical plate 6 is placed diagonally between the tablet computer 4 and the glass plate G at an angle of 45 degrees. The tablet computer 4 has a display surface facing upward, and is connected to a power source (not shown), continuously displaying content to be shown on the show window 1. The combination of the tablet computer 4 and the optical plate 6 constitutes an aerial image display device.

The optical plate 6 is a retro-transmissive optical element used in aerial imaging technology. A retro-transmissive optical plate refers to an optical element that provides retroreflection in the in-plane direction and transmission in the normal direction for light rays incident on the plate surface.

For example, as the optical plate 6, an optical imaging element (two-surface orthogonal reflector) described in Japanese Patent Published Application No. 2011-175297 may be used. This element is formed by arranging numerous planar light-reflecting surfaces orthogonally to each other at regular intervals. Alternatively, a structure such as a two-surface corner reflector with reflective surfaces on the sides of rectangular holes, as described in Japanese Patent No. 4900618, may be used.

That is, under specific conditions of incident light, the optical plate 6 retroreflects the component parallel to the plate plane while maintaining the orthogonal component unchanged. As a result, the image on the display screen 5 of the tablet computer 4 forms a real image 5r in a position symmetrical with respect to the optical plate 6.

Therefore, the distance between the optical plate 6 and the display screen 5 of the tablet computer 4 is equal to the distance between the optical plate 6 and the real image 5r, and in the illustrated arrangement, the real image 5r appears as an aerial image floating outside the window. In this embodiment, since the tablet computer 4 is used, the aerial image floating outside the window can be freely changed or animated.

The interior of the closed space S covered by the housing 2 is designed to minimize light reflection and scattering. For example, all internal wall surfaces are coated with black pigment or covered with a dark sheet.

In this embodiment, all internal wall surfaces of the closed space S are covered with a dark sheet 8 having a visible light reflectance of 2% or less, preferably 0.5% or less. Such a dark sheet can be formed by using a black resin such as lacquer or cashew oil and forming a fine uneven structure on its surface.

In this way, light other than that of the formed aerial image is hardly visible, and the effect is achieved that an image appears to directly emerge from the wall itself. Preferably, if the entire outer surface of the wall W is also black, this effect can be maximized.

Furthermore, by incorporating a depth camera sensor 9 equipped with infrared LEDs and an infrared camera in the window frame, it becomes possible to manipulate the aerial image floating outside the show window by hand. For example, one can move or rotate the aerial image, which is expected to attract attention. As such a depth camera sensor 9, a RealSense (registered trademark) by Intel Corporation may be used.

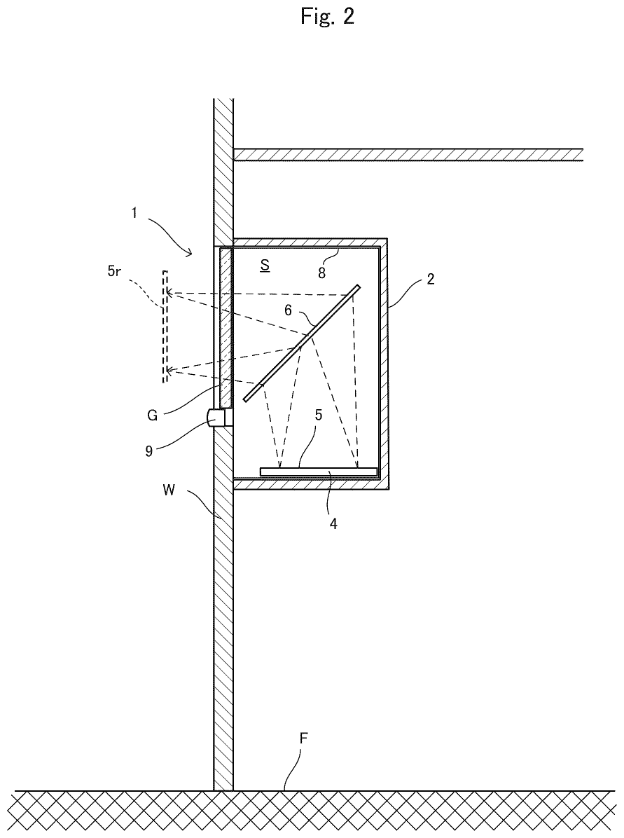

In FIG. 1, the depth camera sensor 9 is provided at the upper part of the window frame and emits infrared rays downward toward the operator's hand, but alternatively, as shown in FIG. 2, it may be installed at the lower part of the window frame to emit infrared rays upward.

### Example 2

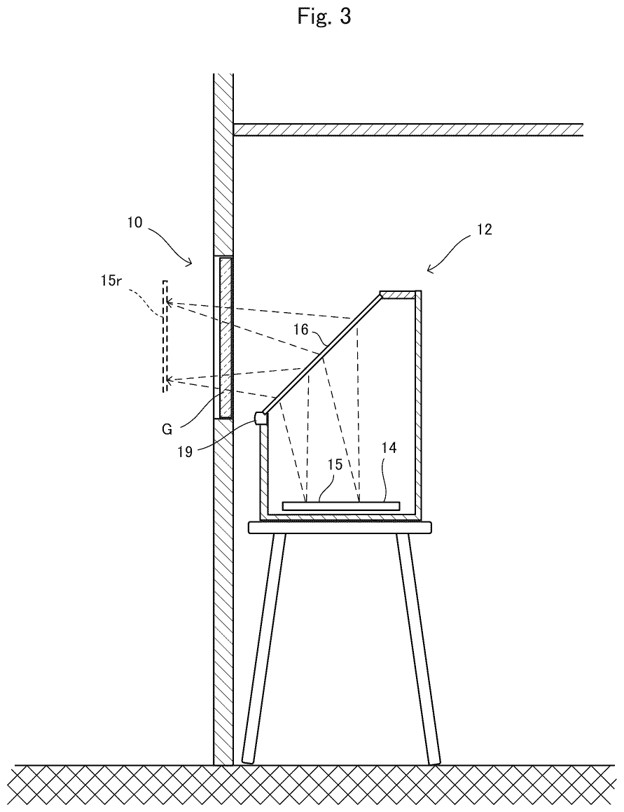

Next, referring to FIG. 3, Example 2 of the show window according to the present invention will be described. In Example 1, the aerial image display device is structurally integrated inside the window. In contrast, in Example 2, the aerial image display device is provided independently of the window and can be freely repositioned. Therefore, a window used as a show window can also function as an ordinary window, or any arbitrary window can be used as a show window.

That is, the window of a show window 10 in Example 2 is not a special one provided specifically for the show window, but may be any ordinary window. A glass plate G is fitted into this window, and an aerial image display device 12 is installed on the inner side of the glass plate. In this example, a table 13 is placed near the wall having the window, and the aerial image display device 12 is placed on top of the table 13.

The aerial image display device 12 has a tablet computer 14 installed inside, and an optical plate 16 is arranged diagonally facing the window. The angle of the optical plate 16 with respect to the horizontal plane is 90 degrees, and the display screen 15 of the tablet computer 14 is positioned horizontally. As a result, the image displayed on the display screen 15 of the tablet computer 14 forms a real image 15r through the window.

Since the distance between the real image 15r and the optical plate 16 is equal to the distance between the display screen 15 of the tablet computer 14 and the optical plate 16, the height of the table 13, the position of aerial image display device 12, and the position of the tablet computer 14 are adjusted so that the real image 15r is formed at an appropriate location. If necessary, a height-adjusting pedestal or the like may be installed on the table 13.

Increasing the distance between the display screen 15 of the tablet computer 14 and the optical plate 16 increases the distance between real image 15r and the optical plate 16, but narrows the viewing angle. Using a larger optical plate can widen the viewing angle to some extent, allowing the distance between the tablet computer 14 and the optical plate 16 (and thus between real image 15r and the optical plate 16) to be somewhat extended.

Although the means for supplying power to the tablet computer 14 is omitted in the figure, an ordinary commercial power supply is used. As in Example 1, the optical plate 16 is a retro-transmissive optical element. According to this embodiment, a general aerial image display device can easily turn any window into a show window.

Furthermore, as in Example 1, by incorporating a depth camera sensor 19 at the lower end of the optical plate 16, it becomes possible to manipulate the aerial image floating outside the show window by hand. For example, one can move or rotate the aerial image, which is expected to attract attention. Again, as such a depth camera sensor 9, a RealSense (registered trademark) by Intel Corporation may be used.

### Example 3

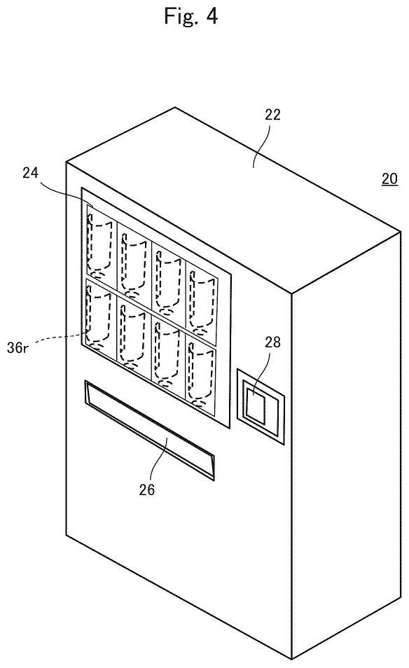

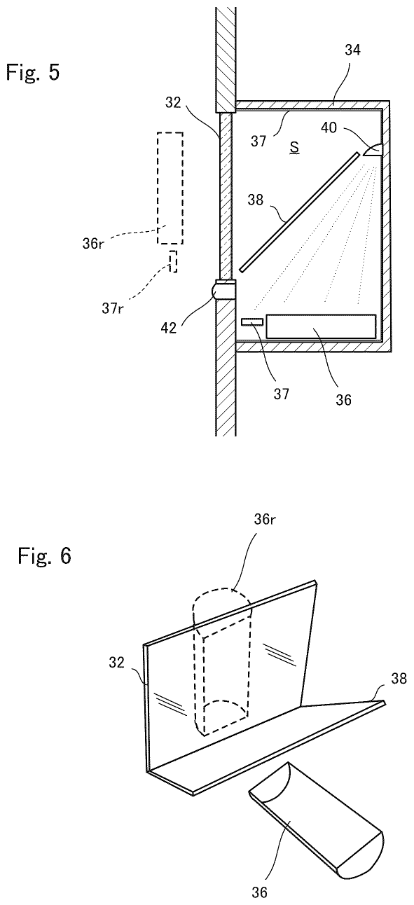

Next, referring to FIGS. 4 to 6, Example 3 of the show window according to the present invention will be described. Here, an application to a drink can vending machine is shown. FIG. 4 is a perspective view showing a vending machine equipped with a show window according to Example 3. FIG. 5 is a partial sectional view showing the show window of the vending machine shown in FIG. 4, and FIG. 6 is a partial perspective view explaining the positional relationship among the main components of the aerial image display device that constitutes the show window of the vending machine.

As shown in FIG. 4, the vending machine 20 includes a rectangular main body 22, a show window 24 provided on its front surface, a product outlet 26 provided below the show window 24, and a payment unit 28 provided on the right side of the show window 24. Although not shown in the drawings, inside the main body 22 are provided storage racks for drink cans, an ejection mechanism for delivering the stored cans to the product outlet 26 and the like.

As shown in FIG. 5, the show window 24 comprises a transparent resin plate 32 fitted into the main body 22 to form a window, a housing 34 shaped as a hollow rectangular body open on the left side and fixed to the inner surface of the main body 22 so as to form a closed space S inside the transparent resin plate 32, a drink can sample 36 placed on the bottom surface of the housing 34, an optical plate 38 positioned diagonally at an angle of 45 degrees with respect to both the transparent resin plate 32 and the sample 36, and an LED light 40 that illuminates the sample 36 from above. The optical plate 38, like in Example 1, is a retro-transmissive optical element such as a two-surface orthogonal reflector or a two-surface corner reflector.

When the sample 36 is illuminated by the LED light 40, its reflected light passes through the optical plate 38 by retro-transmission and forms a real image 36r outside transparent resin plate 32, as in Example 1. An operation button 37 is provided on the left side of the sample 36, and this button 37 is also illuminated by the LED light 40, forming a real image 37r below the real image 36r of the sample 36.

Furthermore, a motion sensor 42 consisting of infrared LEDs and an infrared camera is provided below the transparent resin plate 32, allowing detection of finger movement by the user near the real image 37r of the operation button 37. When a gesture pressing the real image 37r of the operation button 37 is detected, the corresponding drink can is judged to have been selected, and the product is dispensed through the product outlet 26. Thus, a non-contact interface is implemented.

The sample 36 and its real image 36r are mirror-symmetrical with respect to the optical plate 38. Therefore, for the real image 36r to appear as a drink can image, the concave surface inside the sample 36 must be positioned facing upward, as shown in FIG. 6. In other words, when projecting a three-dimensional image, the convex-concave relationship between the visible aerial image and the object to be projected is reversed. The concave inner surface of the sample 36 is printed with the outer design of the drink can.

As in Example 1, all inner walls of the closed space S covered by the housing 34 are covered with a dark sheet 37 having a visible light reflectance of 2% or less, preferably 0.5% or less. Such a dark sheet can be formed using a black resin such as lacquer or cashew oil, with fine irregularities formed on its surface. In this way, light other than that of the aerial image is hardly visible, and the effect is achieved that an image appears to emerge directly from a blank wall.

### INDUSTRIAL APPLICABILITY

According to the show window of the present invention, it is possible to produce the effect that an image appears to emerge directly from a wall. When a person passes by the show window, an unexpectedly floating image enters their field of vision, naturally drawing their attention. Thus, a promotional effect for products can be expected.

The aerial image display device according to the present invention has been described based on specific embodiments, but the present invention is not limited to these examples. Modifications may be made without departing from the spirit of the invention, and the techniques described in the embodiments may be combined or used together with known technologies.

For example, in Example 1 above, a tablet computer is used as the object to be projected that generates the aerial image, but the present invention is not limited to this. A liquid crystal display connected to an ordinary personal computer may also be used.

In Example 3 above, the drink can sample used as the object to be projected is illuminated from above and reflects light to glow, but the present invention is not limited to this. For instance, the drink can sample may be made of translucent milky-white resin with printed designs on its surface, illuminated from below so that the resin surface glows, and that light may be projected to form an image.

### DESCRIPTION OF REFERENCE SYMBOLS

1, 10 Show window
2 Housing
4, 14 Tablet computer
5, 15 Display screen
5r, 15r Real image
6, 16 Optical plate
8 Dark sheet
9, 19 Depth camera sensor
12 Aerial image display device
13 Table
20 Vending machine
22 Vending machine body
24 Show window
26 Product outlet
28 payment unit
32 Transparent resin plate
34 Housing
36 Sample
36r Sample real image
37 Dark sheet
37 Operation button
37r Operation button real image
38 Optical plate
40 Illumination
42 Motion sensor
F Floor
G Glass plate
W Wall

1.-5. (canceled)

6. A show window comprising:
a window on a wall surface; and
an aerial image display device provided inside a housing on the inner side of the window,
wherein the aerial image display device projects an aerial image to the outside of the window,
wherein the aerial image display device comprising a light source and a retro-transmissive optical plate, and
wherein the inner wall surfaces of the housing have a visible light reflectance of 2% or less.

7. The show window according to claim 6,
wherein fine irregularities are formed on the surface of lacquer or cashew oil coated on the inner wall surfaces of the housing.
